(19) United States
(12) Patent Application Publication
(10) Pub. No.: US 2012/0255982 A1
(43) Pub. Date: Oct. 11, 2012

(54) Dean's easy Hold GPS Mount

(76) Inventor: Dean F. Craig, Aurora, IL (US)

(21) Appl. No.: 13/442,224

(22) Filed: Apr. 9, 2012

Related U.S. Application Data
(60) Provisional application No. 61/516,830, filed on Apr. 8, 2011.

(51) Int. Cl. B60R 7/06

(52) U.S. Cl. 224/483

(57) ABSTRACT

The invention provides an efficient means of mounting a GPS unit in a vehicle. The Dean's Easy Hold GPS Mount comprises a Plexiglas mounting base that is designed to mount to the vehicle's dashboard. The present invention supports and holds a hand-held GPS unit by means of peel and stick, adhesive backed VELCRO® strips.

### CLAIM OF PRIORITY

This patent application claims priority under 35 USC 119 (e) (1) from U.S. Provisional Patent Application Ser. No. 61/516,830 filed Apr. 8, 2011, of common inventorship herewith entitled, “Dean's Easy Hold GPS Mount.”

### FIELD OF THE INVENTION

The present invention pertains to the field of mounting bases for electronic devices, and more specifically to the field of mounting bases for GPS devices in vehicles.

### BACKGROUND OF THE INVENTION

The prior art has put forth several designs for mounting systems in vehicles and GPS systems. Among these are:

U.S. Pat. No. 7,568,670 to David Wang describes flexible mounting devices for navigational and entertainment displays for use within a vehicle. One embodiment comprises a flexible gooseneck with a magnetic base on one end for holding a display, and a suction cup on the other end for attaching to a windshield. Another embodiment comprises a flexible neck, which is firmly attached to the dashboard with a sticky gel pad, and a counter weight attached to the back end of the flexible neck. This counter weight balances the weight of the display on the front end and establishes a stable support.

U.S. Pat. No. 7,295,921 to Larry Spencer, Mike Mouser, Jeffrey A. Millington, Roger A. Stevens, and Christopher J. Hook describes a navigation system with a display and keyboard cradled in a docking station mounted inside a vehicle. This docking station includes an electrical connector connected to the vehicle power supply, an electrical connector connected to a GPS antenna, and electrical connector connected to a display extension harness. The navigational system computer slides into the docking station and simultaneously makes electrical contact with the vehicle power supply. These docking stations are fixedly mounted in a plurality of vehicles and the navigation system is transportable among multiple vehicles having the docking station.

U.S. Pat. No. 6,259,399 to Norman F. Krasner describes a GPS receiver having multiple GPS antennas which are coupled to one digital memory or several digital memories to store digitized signals obtained through the multiple GPS antennas. An objective of this embodiment is to track objects using GPS receivers contained within garments.

None of these prior art references describe the present invention.

### SUMMARY OF THE INVENTION

It is an object of the present invention to provide a mounting display for a handheld GPS unit to be mounted in vehicles.

### BRIEF DESCRIPTION OF THE DRAWINGS

FIG. 1 is a perspective side view of a GPS unit mounted in the present invention which comprises a GPS suction mount, a mounting plate, and a base which adheres to the vehicle's dashboard.

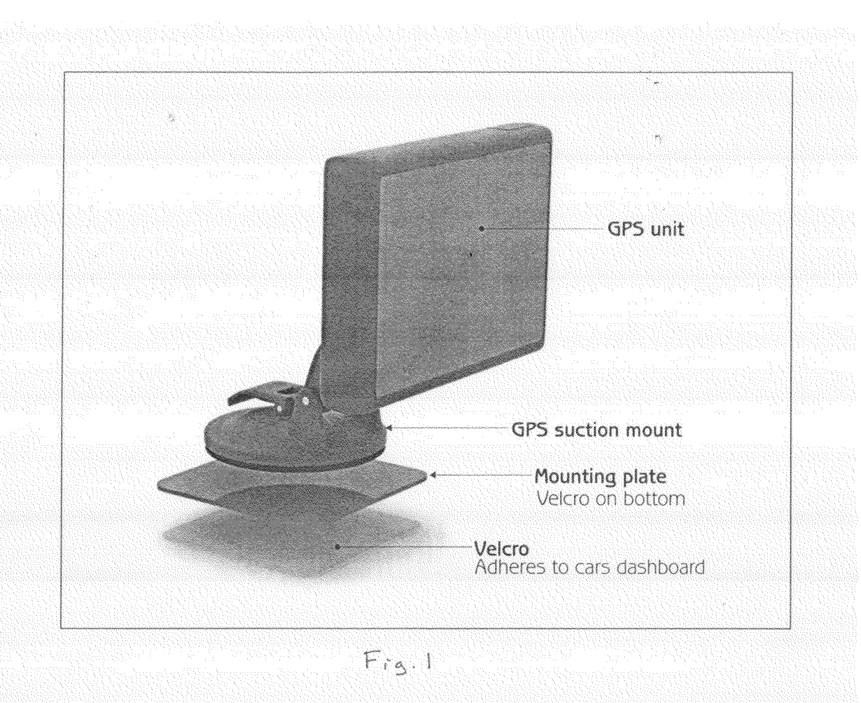

### DETAILED DESCRIPTION OF THE INVENTION

Digital cameras record images and transmit those images through telephone lines and satellites around the world. Cell phones, laptop computers and wireless technology provide capabilities to keep up with world events, download movies and music and games, call or email friends and family and business associates. Personal electronic devices are smaller, more compact, increasingly powerful and integrated. Another functional and interesting example of electronic wizardry is Global Positioning System technology known as GPS. Using a series of orbiting satellite transmitters and earthbound mobile receivers, GPS allows one to instantly identify one's location and follow a designated map or route to where one is going. GPS systems are very popular among highway drivers and often are attached to hands free mounting displays in vehicles. Existing embodiments for mounting GPS units in vehicles have glaring drawbacks. They generally mount to the windshield by means of a mounting display attached to the windshield. This mounting display blacks a substantial portion of the driver's view. Its power cord runs down the windshield and across the dashboard, becoming another hindrance and obstacle. This mounting display also has a suction cup that loses its suction and falls, creating a dangerous driving experience.

The present invention, hereinafter referred to as Dean's Easy Hold GPS Mount, provides an efficient means of mounting a GPS unit in a vehicle. The Dean's Easy Hold GPS Mount comprises a Plexiglas mounting base that is designed to mount to the vehicle's dashboard. The present invention supports and holds a hand-held GPS unit by means of peel and stick, adhesive backed VELCRO® strips. The adhesive used will not leave a sticky residue on the surface when it is removed. The mounting plate or base is a flat sheet of Plexiglas, approximately one sixteenth inch in thickness and three inches square with rounded corners. This mounting base has VELCRO® strips across both its upper and lower surfaces. The Dean's Easy Hold kit contains ample adhesive-backed VELCRO® strips to establish a permanent mounting spot on the preferred portion of the dashboard and to affix VELCRO® to the rear of the GPS unit. The hooks and loops of the mating VELCRO® strips are applied such that the underside of the mounting plate mates with the dashboard VELCRO®, and the upper surface of the mounting plate mates with the rear surface of the GPS unit.

In an alternative embodiment, a bean-bag holder can be mounted on the dash board or other desired location to support the GPS unit.

The driver chooses the best site for mounting the GPS unit, keeping it in easy view and positioning it to keep the power cord out of the way. The Dean's Easy Hold accommodates the GPS unit in either a vertical or horizontal orientation. The Dean's Easy Hold provides a very secure mounting base and allows for easy removable transport of the GPS unit. Installing and using the Dean's Easy Hold GPS Mount is simple, inexpensive and maintenance free.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A mounting display device for a handheld GPS unit to be mounted in vehicles, comprising: a plexiglas™ mounting base that is designed to mount to the vehicle's dashboard.

2. The mounting display device of claim 1 wherein the mounting base is positioned on the dash board or other desired location by means of peel and stick, adhesive backed VELCRO® strips.

3. The mounting display device of claim 2 wherein the adhesive used will not leave a sticky residue on the surface when it is removed.

4. The mounting display device of claim 1 wherein the mounting plate or base is a flat sheet of Plexiglas, approximately one sixteenth inch in thickness and three inches square with rounded corners.

5. The mounting display device of claim 4 wherein the mounting base has VELCRO® strips across both its upper and lower surfaces.

6. The mounting display device of claim 5 wherein the hooks and loops of the mating VELCRO® strips are applied such that the underside of the mounting plate mates with the dashboard VELCRO®, and the upper surface of the mounting plate mates with the rear surface of the GPS unit.

7. The mounting display device of claim 1 further comprising a bean-bag holder attached to the mounting base.
